(19) United States
(12) Patent Application Publication
(10) Pub. No.: US 2003/0183037 A1
(43) Pub. Date: Oct. 2, 2003

(54) Pedal mounting structure

(76) Inventors: Sadahiro Kawahara, Ebina-shi (JP); Sadayuki Kezuka, Atsugi-shi (JP); Hiroyuki Mizuma, Hadano-shi (JP); Naoyuki Sugiyama, Tokyo (JP)

Correspondence Address: MCDERMOTT WILL & EMERY, 600 13TH STREET, N.W., WASHINGTON, DC, 20005-3096, US

(21) Appl. No.: 10/363,042

(22) PCT Filed: Jul. 10, 2002
(86) PCT No.: PCT/JP02/06985

(30) Foreign Application Priority Data
Jul. 17, 2001 (JP) 2001-217074

(51) Int. Cl. G05G 1/14

(52) U.S. Cl. 74/512

(57) ABSTRACT

A pedal mounting structure which includes a pedal arm (3) including a pedal (2); a supporting unit (5, 6) pivotally supporting the pedal arm (3) as turnable in accordance with a stepping operation onto the pedal (2); and a first fixture (8) and a second fixture (9) for fitting the supporting unit (5, 6) to a vehicle body (10). The second fixture (9) is provided in a position closer to the pedal (2) than the first fixture (8), and is fitted to a portion having a smaller deformation upon a collision of a vehicle than a portion to which the first fixture (8) is fitted.

### TECHNICAL FIELD

The present invention relates to a mounting structure of a pedal for a vehicle such as an automobile and the like.

### BACKGROUND ART

Japanese Patent Application Laid-open No. 2000-238550 discloses a structure in that an accelerator pedal is mounted on a place close to a lower portion of a dash panel, which moves relatively less toward a rear side in the event of deformation of the dash panel attributable to a collision of a vehicle or the like, in order not to discomfort a driver stepping on the accelerator pedal owing to movement of an accelerator pedal arm in association with movement of an attachment for an accelerator pedal bracket toward the rear side of a car body.

### DISCLOSURE OF INVENTION

As shown in FIG. 1, one conceivable pedal mounting structure is a structure in which a pedal arm 3 provided with a pedal 2 being fixed to a lower end thereof, is pivotally supported by a pedal bracket 6 which is mounted on a dash panel 10 via a bracket 12.

However, according to this pedal mounting structure, if stress is applied to a car body from a front side of the car body (from left sides of FIGS. 1 and 2; hereinafter referred to as the “front”) in the event of a collision of a vehicle or the like, the dash panel 10 penetrates into a driver compartment as shown in FIG. 2, and the pedal bracket 6 and the pedal 2 move toward a rear side of the car body (toward right sides of FIGS. 1 and 2; hereinafter referred to as the “rear”). There is a risk of discomforting a driver who is stepping on the pedal 2.

In other words, since the pedal bracket 6 and the dash panel 10 are joined together at one fixing point 19 according to the above-described constitution, if a moving amount toward the rear in the vicinity of the fixing point 19 of the dash panel 10 and the pedal bracket 6 is defined as a moving distance Dr, the pedal 2 moves as equivalent to a moving distance D1r (≈Dr), which is almost as long as the moving distance Dr, in the case when the stress is applied to the car body from the front.

In the meantime, a distance Lr secured between a stepping position of the pedal 2 (a contact point of the pedal 2 and a foot of the driver) and a fixed point P on a floor panel in a normal state shown in FIG. 1 becomes a distance L1r (=Lr−D1r) as shown in FIG. 2, whereby a space around feet of the driver is narrowed.

It is an object of the present invention to provide a pedal mounting structure surely suppressing movement of a pedal toward a rear side of a car body when stress is applied from a front side of the car body, thus reducing discomfort given to a driver who is stepping on the pedal, in the event of a collision of a vehicle or the like.

The first aspect of the present invention provides a pedal mounting structure comprising: a pedal arm supporting a pedal; a supporting unit pivotally supporting the pedal arm as turnable in accordance with a stepping operation onto the pedal; and a first fixture and a second fixture for fitting the supporting unit to a car body, the second fixture being provided in a position closer to the pedal than the first fixture, and fitted to a portion having a smaller deformation upon a collision of a vehicle than a portion to which the first fixture is fitted.

### BRIEF DESCRIPTION OF DRAWINGS

FIG. 1 is an explanatory cross-sectional view showing one example of a pedal mounting structure in a state that a pedal is mounted onto a car body.

FIG. 2 is an explanatory cross-sectional view showing the example of the pedal mounting structure in a state of a collision of a vehicle.

FIG. 3 is an exploded perspective view showing a pedal mounting structure according to an embodiment of the present invention.

FIG. 4 is an explanatory cross-sectional view showing the pedal mounting structure according to the embodiment of the present invention in a state that a pedal is mounted onto a car body.

FIG. 5 is an explanatory cross-sectional view showing the pedal mounting structure according to the embodiment of the present invention in a state of a collision of a vehicle.

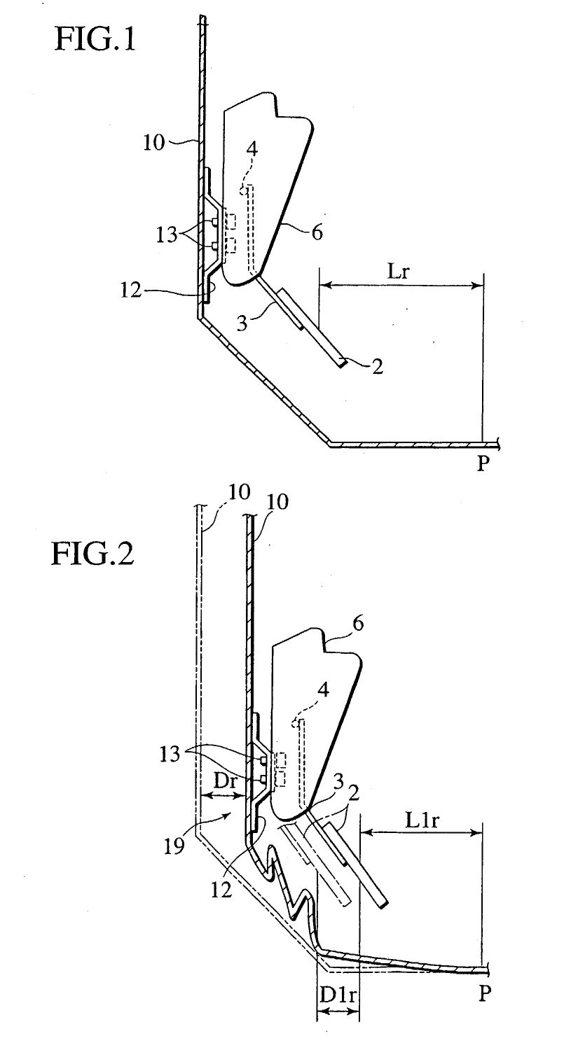

### BEST MODE FOR CARRYING OUT THE INVENTION

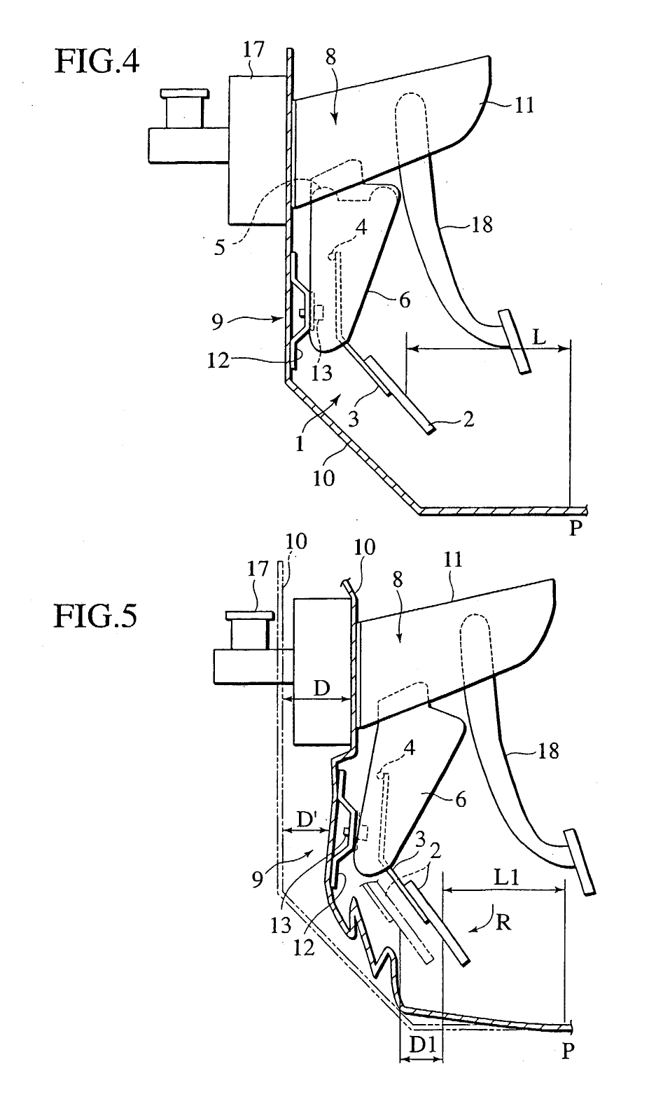

Now, one embodiment of a pedal mounting structure according to the present invention will be described in detail based on the accompanying drawings. In the drawings, members identical to those in the pedal mounting structure previously described (hereinafter referred to as a “comparative example”) are denoted by identical reference numerals. In FIGS. 4 and 5, left sides thereof correspond to a front side of a car body (the “front”), right sides thereof correspond to a rear side of the car body (the “rear”) and upper sides thereof correspond to an upside.

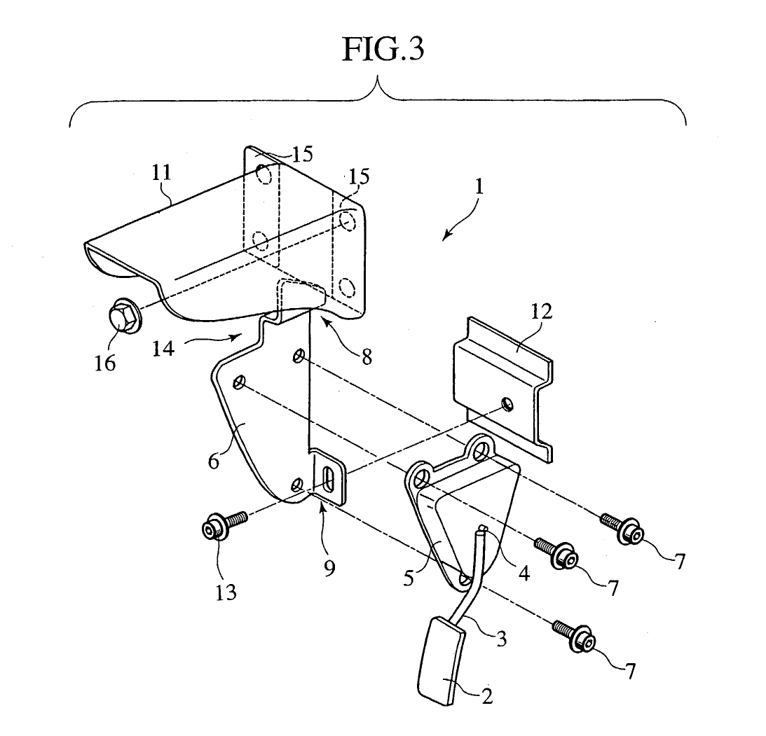

As shown in FIG. 3, an accelerator pedal device 1 includes an accelerator pedal arm 3 provided with an accelerator pedal 2 on a lower portion thereof, and an accelerator pedal unit 5 which supports an upper portion of the accelerator pedal arm 3 pivotally as turnable about a shaft 4 in accordance with a stepping operation onto the accelerator pedal 2.

Inside the accelerator pedal unit 5, incorporated are a connecting mechanism to a throttle cable for controlling an engine (not shown) as a driving power source in accordance with a stepping amount of the accelerator pedal 2, stabilizing means such as a coil spring for stabilizing the accelerator pedal arm 3 in a specified position, and the like.

The accelerator pedal unit 5 is fixed by conclusion to an accelerator pedal bracket 6 with bolts 7 or the like, and mounted onto a dash panel 10 on the side of the car body at an upper fixing point 8 (as a first fixture) and at a lower fixing point 9 (as a second fixture) via the accelerator pedal bracket 6. (The accelerator pedal unit 5 and the accelerator pedal 6 collectively constitute a supporting unit as defined in the claims of the present invention.)

To be more precise, the upper fixing point 8 of the accelerator pedal bracket 6 is joined by means of welding or the like to a brake pedal bracket 11, which is a portion having a large deformation moving amount toward the rear in the event of a collision.

Meanwhile, the lower fixing point 9 is fixed by conclusion with a bolt 13 to a fitting bracket 12 being connected to a position close to a lower portion of the dash panel 10, which is the position having a smaller deformation moving amount toward the rear than the upper fixing point 8.

Moreover, a cranked portion 14 is formed between the upper fixing point 8 and the lower fixing point 9 of the accelerator pedal bracket 6 as an easily deformable portion.

Regarding a configuration of the accelerator pedal 2, the upper fixing point 8 and the lower fixing point 9, the accelerator pedal 2 is provided in a manner that a perpendicular line dropping from a stepping position of the accelerator pedal 2 down to a straight line connected between the upper fixing point 8 and the lower fixing point 9 is located lower than the lower fixing point 9.

The brake pedal bracket 11 includes a brake pedal 18 and is fixed by conclusion with nuts 16 to the dash panel 10 at flanges 15 and 15 at a front side thereof. In front thereof beyond the dash panel 10, disposed is a vacuum-operated brake booster 17 of a brake apparatus.

The accelerator pedal device 1 is fitted to the car body as described above.

Next, description will be made regarding movement of the accelerator pedal device 1 in the event of a collision of a vehicle based on FIG. 4 and FIG. 5.

FIG. 4 shows a normal state. In this event, a distance L is secured between the stepping position of the accelerator pedal 2 (a contact point of the accelerator pedal 2 and a foot of the driver) and a fixed point P on a floor panel. if stress is applied to the car body from the front in the event of a collision of a vehicle or the like, then as shown in FIG. 5, the dash panel 10 penetrates into a driver compartment and the accelerator pedal bracket 6 moves toward the rear in association therewith.

In this event, as opposed to the comparative example shown in FIG. 2, the accelerator pedal bracket 6 in this embodiment has the structure that the upper fixing point 8 thereof is set to the brake pedal bracket 11, which is the portion having the large deformation moving amount toward the rear in the event of a collision of a vehicle, and that the lower fixing point 9 is set to the position close to the lower portion of the dash panel 10, which is the portion having the smaller deformation moving amount toward the rear than the upper fixing point 8. Therefore, when the stress is applied from the front of the car body, a moving distance D′ of the lower fixing point 9 becomes smaller than a moving distance D of the upper fixing point 8 (D′<D), whereby a moving distance D1 of the accelerator pedal 2 can be made smaller than the moving distance D1r in the comparative example.

This is due to development of a turn R in a direction clockwise in FIG. 5 to move the accelerator pedal 2 toward the front, which is attributable to a difference ΔD (=D−D′) between the mutual moving distances of the fixing points 8 and 9.

Moreover, since the moving distance D1 of the accelerator pedal 2 toward the rear is smaller than the moving distance D1r in the comparative example as described above, the distance L between the stepping position of the accelerator pedal 2 and the fixed point P on the floor panel can be larger than the distance L1r in the comparative example shown in FIG. 2, whereby a space around feet of the driver can be secured.

According to the structure of the above-described embodiment, the accelerator pedal unit 5 is mounted onto the dash panel 10 on the car body at the upper fixing point 8 and the lower fixing point 9 via the accelerator pedal bracket 6. In addition, the upper fixing point 8 of the accelerator pedal bracket 6 is set to the portion having the large deformation moving distance D toward the rear in the event of the collision of the vehicle, and the lower fixing point 9 is set to the position having the smaller deformation moving distance D′ toward the rear than the upper fixing point 8. Accordingly, the turn R develops in a direction to move the accelerator pedal 2 toward the front owing to the difference ΔD (=D−D′) between the mutual moving distances of the upper and lower fixing points 8 and 9 of the accelerator bracket 6, and movement of the accelerator pedal 2 toward the rear side of the car body is suppressed, whereby it is possible to reduce discomfort given to the driver who is stepping on the accelerator pedal 2, by suppressing movement of a pedal toward the rear side of the car body, and to secure the space around the feet after the collision.

Furthermore, as described above, the accelerator pedal 2 approaches the dash panel 10 moving toward the rear by deformation (turns relatively in a direction toward the front with respect to the dash panel 10). Accordingly, if the moving amount of the dash panel 10 to the rear is large, the accelerator pedal abuts on the dash panel 10, a pedal stopper (not shown) provided on the dash panel 10, or the like. Force acting on the accelerator pedal 2 from such an abutting portion acts in a direction to close the accelerator pedal 2, i.e. to a direction to reduce revolutions of the engine as the driving power source, thus reducing the discomfort given to the driver.

In addition, according to the structure of this particular embodiment, the upper fixing point 8 is provided on the brake pedal bracket 11 to which the vacuum-operated brake booster of the brake apparatus is disposed in front thereof, whereby the stress on the car body in the event of the collision of the vehicle or the like is applied to the dash panel 10 via the vacuum-operated brake booster. Accordingly, a large deformation moving amount of the brake pedal bracket 11 toward the rear is secured.

Moreover, the cranked portion 14 as the easily deformable portion, provided between the upper fixing point 8 and the lower fixing point 9 of the accelerator pedal bracket 6, absorbs deformation stress acting on the accelerator pedal bracket 6 and the accelerator pedal unit 5, which is attributable to the difference ΔD of the moving distances between the upper fixing point 8 and the lower fixing point 9. In this way, it is possible to develop the turn R in the direction to move the accelerator pedal toward the front while protecting the pedal bracket 6 and the accelerator pedal unit 5.

The present disclosure relates to subject matter contained in Japanese Patent Application No. 2001-217074, filed on Jul. 17, 2001, the disclosure of which is expressly incorporated herein by reference in its entirety.

The preferred embodiment described herein is illustrative and not restrictive, and the invention may be practiced or embodied in other ways without departing from the sprit or essential character thereof. The scope of the invention being indicated by the claims, and all variations which come within the meaning of claims are intended to be embraced herein.

### INDUSTRIAL APPLICABILITY

As described above, according to the pedal mounting structure of the present invention, a pedal unit is fixed to a dash panel at two fixing points of a first fixture and a second fixture, and the first fixture and the second fixture are fitted severally to a portion having a large deformation in the case when stress is applied to a car body from a front side thereof in the event of a collision of a vehicle or the like and a portion having a small deformation. Accordingly, movement of a pedal toward the rear of the car body can be suppressed, whereby discomfort given to a driver stepping on the pedal can be reduced. Therefore, the present invention is useful as a pedal mounting structure.

1. A pedal mounting structure comprising:
a pedal arm supporting a pedal;
a pedal unit pivotally supporting the pedal arm as turnable in accordance with a stepping operation onto the pedal; and
a first fixture and a second fixture for fitting the supporting unit to a vehicle body, the second fixture being provided in a position closer to the pedal than the first fixture, and fitted to a portion having a smaller deformation upon a collision of a vehicle than a portion to which the first fixture is fitted.

2. The pedal mounting structure according to claim 1, wherein an output of a driving power source of the vehicle is controlled in accordance with an amount of stepping on the pedal.

3. The pedal mounting structure according to claim 1, wherein the first fixture is provided on a brake bracket to which a brake booster is disposed on a front side of the vehicle body.

4. The pedal mounting structure according to claim 1, wherein the supporting unit is configured with an easily deformable portion provided between the first fixture and the second fixture.

5. The pedal mounting structure according to claim 1, wherein the second fixture fixes the supporting unit to the vehicle body via a fitting bracket.

6. A pedal mounting structure comprising:
a pedal arm supporting a pedal;
a supporting unit pivotally supporting the pedal arm as turnable in accordance with a stepping operation onto the pedal;
a first fixture and a second fixture for fitting the supporting unit to a vehicle body, the second fixture being provided in a position closer to the pedal than the first fixture; and
controlling means for controlling deformation of the vehicle body in a manner that a displacement of the second fixture is made smaller than a displacement of the first fixture upon a collision of a vehicle.

7. A pedal mounting method comprising:
preparing a pedal device, the pedal device including a pedal arm having a pedal, a supporting unit pivotally supporting the pedal arm as turnable in accordance with a stepping operation onto the pedal, and a first fixture and a second fixture for fitting the supporting unit to a vehicle body, the second fixture being provided in a position closer to the pedal than the first fixture;
fitting the first fixture of the pedal device to the vehicle body; and
fitting the second fixture of the pedal device to the vehicle body in a manner that the second fixture is fitted to a position having a smaller deformation upon a collision of a vehicle than a position to which the first fixture is fitted.

8. The pedal mounting method according to claim 7, wherein an output of a driving power source of a vehicle is controlled in accordance with an amount of stepping on the pedal of the pedal device.

9. The pedal mounting method according to claim 7, wherein the first fixture of the pedal device is fitted to the vehicle body via a brake bracket to which a brake booster is disposed on a front side of the vehicle body.

10. The pedal mounting method according to claim 7, wherein the supporting unit of the pedal device is configured with an easily deformable portion provided between the first fixture and the second fixture.

11. The pedal mounting method according to claim 7, wherein the second fixture of the pedal device is fixed to the vehicle body via a fitting bracket.
